(19) United States
(12) Patent Application Publication
(10) Pub. No.: US 2009/0151285 A1
(43) Pub. Date: Jun. 18, 2009

(54) FLOOR, WALL OR CEILING PANEL

(75) Inventors: Udo Tünte, Raesfeld (DE); Matthias Wolf, Coesfeld-Lette (DE)

Correspondence Address: Jason H. Vick;Sheridan Ross, PC, Suite # 1200, 1560 Broadway, Denver, CO, 80202, US

(73) Assignee: HULSTA-WERKE HULS GMBH & CO. KG, Stadtionn (DE)

(21) Appl. No.: 11/917,489

(22) PCT Filed: Jul. 3, 2006
(86) PCT No.: PCT/EP06/06471

§ 371 Date: Feb. 6, 2009

(30) Foreign Application Priority Data
Jul. 4, 2005 (DE) 10 2005 031 486.4

(51) Int. Cl. E04F 15/22; E04B 1/62; B32B 27/18

(52) U.S. Cl. 52/403.1; 52/515; 428/297.4; 428/194; 428/221

(57) ABSTRACT

The invention relates to a floor, wall or ceiling panel (2) or strip, which is designed for placing on and/or fastening to a floor, a wall or a ceiling of a room. According to the invention, the panel or the strip has at least one active component with an air pollutant- and/or odorous substance-reducing action.

The invention relates to a floor, wall or ceiling panel which is designed for placing on and/or fastening to a floor, to a wall or to a ceiling of a room. The invention relates moreover to a corresponding strip as well as to a care product for panels or strips. Finally, the present invention relates to a mat, particularly to one which can be rolled up.

Pollutants in interior rooms have come to have special significance, particularly as a result of improvements in the area of energy savings, which bring about a considerable reduction in the rate of air exchange. For instance, pollutants are primarily contained in wood materials, particularly chipboards, tobacco smoke, parquet sealants, paints and varnishes, adhesives, insulation materials and wallpapers. Particularly when there is insufficient ventilation, the pollutants given off by construction materials can lead to health-endangering side effects. Pollutants, particularly in the form of emanations from construction materials and furniture, can lead to headaches, eye irritations and even respiratory diseases. Moreover, odorous substances that are perceived by people as unpleasant or disturbing are sometimes released in rooms.

In order to reduce the concentration of pollutants and odorous substances in the indoor air, the polluted construction materials can be removed which, while promising long-term success, is associated with considerable costs. Furthermore, it is possible to prevent construction materials which emit pollutants and/or odorous substances from giving off contaminants by coating or covering them. Nevertheless, the coatings used here are subject to an ageing or saturation process which limits the effective life of the coating. Moreover, there is the danger that the climatic conditions in the room can be impacted unfavorably by the coating.

The abovementioned problems occur not only in old buildings but sometimes in new buildings as well. What is more, pollutants and odorous materials in the indoor air are also released by the people in a room, for example while cooking or smoking.

It is the object of the present invention to reduce the concentration of air pollutants and odorous substances in rooms in an economical and effective manner without the above-described disadvantages.

The aforementioned object is achieved in a floor, wall or ceiling panel or strip of the type named at the outset in that the panel or the strip has at least one active component with an air pollutant- and/or odorous substance-reducing effect. By virtue of the invention, it is possible for the first time to use slab- or strip-like solid structures provided for covering or for placement on the indoor floor, on the indoor walls, or on the indoor ceiling directly for the reduction of air pollutants or odors in a room. In principle, a building or furniture sheet can also be designed commensurately here, with the slab having a very stiff base material. The building or furniture slab then has at least one active component with an air pollutant- and/or odorous substance-reducing effect. What is more, all features which are described in the example of a floor, wall or ceiling panel or strip can of course also be provided in the other construction materials named here with the effect of reducing contaminants, and are comprised by the invention.

Moreover, the panel can be a slab-shaped component in saleable (final) state for the end consumer or a so-called semifinished product, namely a component which is either not processed or processed only in part. The same also applies, of course, to the strip according to the invention. Moreover, the panel or strip according to the invention is preferably a component which can be used indoors, even though the use of panels or strips with at least one active component with an air pollutant- and/or odorous substance-reducing effect on the outside area of a building is also possible.

Incidentally, the invention is not limited to floor, wall or ceiling panels. As will readily be understood, the features and advantages according to the invention can also be realized in other construction materials such as building or furniture boards, drywall or gypsum fiber slabs such as, in particular, HDF, MDF, OSB boards or chipboards, fitted carpet, textile flooring and wallpapers. All of the features in the following which are described using the example of a floor, wall or ceiling panel or strip can therefore of course be provided advantageously in the other aforementioned construction materials as well and be comprised by the invention.

With the panel according to the invention or the strip according to the invention, it is possible in a simple and cost-effective manner to reduce the harmful or odorous substances within a room without it being necessary to use additional agents or devices to reduce the harmful substances and odors in the room in question. Moreover, panels and strips of the type according to the invention can be manufactured in a simple manner and at little additional cost.

As a result, the invention for panels and strips opens up a completely new area of application, with slab- and strip-shaped construction materials such as panels and strips being able for the first time to be used directly for the reduction in the concentration of contaminants in rooms. Panels and strips are used, for example, in the interior coverings of rooms both in conjunction with room refurbishment and in connection with the construction of new buildings. The effectiveness of the active components depends, among other things, on the concentration of the contaminants in the indoor air and on their density as well as the effective range of the active components. Here, it is possible, for example, that pollutants which are lighter than air, for instance, rise up from the floor area and strike the panels or strips according to the invention in the ceiling area, which leads to a reduction of the concentration of contaminants in the indoor air. If the panels or strips according to the invention are used in a room on the floor, on the walls and on the ceiling, contaminants can be reduced with a particularly high level of effectiveness.

In an especially preferred embodiment of the invention, a provision is made that the panel or the strip has a coated base material and that the active component is integrated into the base material. In connection with the invention, the term “coat” is to be understood as the layer component of a coated base material which has the active component. For example, the active component can be applied onto the base material in a coating process of the base material together with other components of a coating in a layer. This makes an especially simple cost-effective manufacture of the panel or strip according to the invention possible. In principle, however, the base material can also be coated with the pure active component in a separate coating process. Depending on the coated surface and/or the quantity of the active component introduced, it may already be sufficient that only the strips and profiles in a room be coated appropriately. In principle, it is of course also possible to coat all of the panels and strips in a room in order to ensure as great a deposition effect as possible.

Preferably, the top side and/or the bottom side of the base material is coated with the coating containing the active component. A coating can be provided here over the entire surface. Surprisingly, however, it has also been determined in connection with the invention that not all areas of the coating are equally involved in the depletion of odorous substances and pollutants. Depending on the active component and the contaminants to be depleted, certain areas of a base material which is coated over its entire surface are involved more in the depletion than other areas of the base material. This comes as a complete surprise and was discovered in connection with the invention. A fundamental concept of the invention is therefore the provision of an air pollutant- and odorous substance-reducing coating only on areas of the panel or strip, with the depletion of pollutants and odorous substances being ensured all the same with a high degree of effectiveness. Furthermore, the invention is based on the insight that, particularly in catalytic decomposition processes, a partial-surface coating alone, for example of the top side and/or the bottom side and/or the front side(s), can be sufficient to ensure sufficiently high rates of deposition of the relevant pollutants and odorous substances. With its partial-surface coating, the invention is characterized by low consumption of the active component and a low cost of the coating.

In a preferred embodiment of the invention, a provision is made that the top side and/or the bottom side is coated only in the outer edge area near the corner, with it being preferably possible to provide the coating in the form of a strip running around the edges of the panel or the strip. In this context, the invention is based on the insight that the release of air pollutants and odorous substances from the substrate and/or from the panels or strips occurs more intensely in the area of the joints of neighboring panels or strips. Consequently, high deposition rates need to be achieved particularly in the area of the edges and joints. In an alternative embodiment of the invention, a provision is therefore made that the coating having the active component is provided on at least one front side of the panel or strip. The term “front side” is understood here to be a generic term both for the longitudinal and transverse sides of a panel or a strip. As a result, pollutants and odorous substances which are released in the joint area from the floor and/or from the panel or strip can be reduced. Pollutants and odorous substances which are possibly emitted laterally from the panel or the strip can be reduced by coating the front side. With a continuous coating of preferably all front sides of panels or strips manufactured, for example, of a wood material, a complete (edge) seal of the panel or strip can be achieved, so that no pollutants or odorous substances can escape from the panel or strip. A provision can also be made that the front side is coated only over a portion of its surface, particularly in the area of the upper and lower edges.

In a particularly cost-effective embodiment of the invention, a provision is made that only the front sides of the panel or strip is coated with a coating containing the active component and that the top side and/or the bottom side is not coated with the active component. As a result of the coating of preferably all front sides, a coating of the top side and/or the bottom side may not be necessary to ensure a high deposition rate for pollutants and odorous substances. This contributes to low manufacturing costs of the panel or the strip according to the invention.

The coating containing the active component preferably has a layer thickness of 0.01 mm to 2 mm, particularly of 0.05 mm to 0.5 mm. Here, floor panels or strips can have a greater layer thickness, since they are subjected to a greater mechanical load. Floor panels can have a layer thickness of 0.02 mm to 0.03 mm, which is in itself sufficient for an adequate deposition effect. The layer thickness depends, among other things, on the type of coating. In the case of a laminate, a melamine resin surface can be provided with a layer thickness of 0.01 mm to 0.5 mm after pressing, preferably from 0.02 to 0.15 mm. In base materials which have a true wood surface, such as MHD/parquet/panels or furniture boards, an application of paint with a layer thickness of 0.02 mm to 0.5 mm, preferably of 0.04 to 0.09 mm, can be provided as a coating. In the aforementioned true wood surfaces, if oil is applied instead of paint, then the layer thickness can be lower, since oils penetrate more strongly into the surface to be coated. Here, the minimal layer thickness can be approx. 0.006 mm. In waxed surfaces on the base material, the layer thickness can be between 0.1 and 1 mm, whereas the layer thickness in layer-forming care products can be 0.002 to 0.1 mm. In the aforedescribed embodiments, the active component is contained in the paint or in the oil.

In principle, it is of course also possible that larger layer thicknesses be selected depending on the mechanical load of the panels or strips and depending on the active component used, the concentration of contaminants in the indoor air and the contaminant-reducing principle. Here, a provision can be preferably made that the coating contains the active component in a concentration of 1 wt. % to 10 wt. %, preferably of 2 wt. % to 5 wt. %. As a result, it is possible to apply the active component in a simple and cost-effective manner to a panel or a strip by coating the base material.

In a layer-forming construction with active substances integrated in the coating, coatings with a layer thickness of 0.001 mm may be sufficient to bring about an effective reduction of contaminants in the indoor air. In such small layer thicknesses, the proportion of the active substances is less than 5 g/m², preferably less than 2 g/m², with the active layer as such also only consisting in part of the active component.

The aforementioned value ranges of the coating are applicable in connection with the coating of components of the likewise aforementioned type for preventing the emission of contaminants from the components, for example through surface-coating or edge-sealing.

If the active component is a catalyst such as TiO₂, for example, then the surface proportion of the surfaces containing the catalyst can be less than or equal to 5% of the space-encompassing surface of floor, wall and ceiling. However, depending on the contaminant load, greater surface proportions of the coated surfaces with respect to the total surface of a room are also possible.

The coating can have a carrier substance containing the active component, such as a paint pigment and/or corundum, for example. In principle, any board component or substance which is usually used in the coating can be provided as a carrier substance. Moreover, the use of carrier substances which are not originally contained in the coating formula is also possible. Consequently, the active substance is fed to the base material via an additive or carrier. In this connection, a provision can be made that the carrier substance is encased by the active component and/or permeated with the active substance. This helps make it easier for active component to be fed together with the carrier substance into a coating formula without the possibility of an uneven distribution or unmixing of the active component in the coating. The carrier substance can preferably be a formula component which is in the coating formula anyway, which leads to a simplification of the coating process.

One preferred embodiment of the panel or strip according to the invention makes a provision that a resin coating, particularly a melamine coating, and/or a paint coat and/or a glazing and/or a paper coating and/or foil coating and/or a non-woven fabric or a mat is provided as a coating with active components. For example, a sheep's wool fiber mat as such can be provided for the coating of the panel or strip, with sheep's wool having contaminant-reducing effect.

The active component can be introduced, for example, into the melamine coating, the paint coating, the glazing or into an overlay. If it is a free-flowing or liquid coating agent, a provision can be made that the coating is sprayed onto the base material. In the aforementioned case, a layer-forming care product and/or an impregnation can be applied onto the base material, with the active component being incorporated into the care agent and/or the impregnation. The impregnation can be a paint or an oil impregnation. In principle, however, it is also possible to introduce the active components into other substance systems such as, for example, dispersion paints. The care product can also be used to treat furniture or the like.

The spraying of the coating onto the base material constitutes a particularly simple and cost-effective option for joining the active component to the base material. Of course, it is also possible in principle, particularly in the case of solid coatings, to press same onto the base material or to adhere them to the base material. In melamine-coated boards (DPL, CPL, HPL), it is possible according to the invention to introduce the agent into the resin bath. This is then followed by the coating of the panels with the resin. In this case, it is not necessary to modify the coating process to apply an active component onto the base material, which simplifies the manufacturing process of the panel or strip according to the invention. Optionally, the protective layer can be renewed in regular intervals in order to ensure a consistently high level of effectiveness of the active component.

In an alternative embodiment of the invention, a provision can be made that the active component is introduced into the base material as such. This can be done, for example in chipboards, by soaking the sawdust in a medium containing the active component. A coating of the base material is then not necessary in all cases, even if the additional coating is not ruled out in every case, either. The active component can be introduced into the base material in liquid, lumpy or fibrous form or as a powder, preferably during the manufacture of the base material itself. In order to ensure a sufficient reduction of the concentration of contaminants in the indoor air, the base material contains the active component preferably in a concentration of 0.1 wt. % to 25 wt. %, preferably of 0.5 wt. % to 20 wt. %, with higher concentrations also being possible in principle. For example, wooden boards can contain the active component in a concentration of 20 wt. %. The fundamental thought of introducing the active component into the base material as such gains its own inventive significance, which is to say it is independent of the above-described coating of the base material with a coating containing the active component.

In order to achieve a high level of effectiveness of a base material designed as a single piece, the dependence of the deposition performance or the dependence of the conversion of the contaminants on the component thickness (raw density), on the diffusion resistance and, possibly, on an encapsulation of the active substance must be taken into account. A base material with a high air permeability, for example a non-woven fabric through which air is able to pass, can contain the active component in a concentration of less than 5 g/m², preferably of less than 2 g/m². For example, a sheep's wool fleece can be used which consists almost completely of active ingredients. If the active component is introduced into the base material, then this has the effect that the contaminants emitted by the base material are bound or decomposed in the interior of the base material itself, so that no emission occurs.

The base material as such can be manufactured from wood, a wood material (MDF, HDF/chipboard/OSB/plywood/glued wood), from a plastic (e.g. polyvinyl chloride, polyurethane, polyolefin) or a mineral- or ceramic-based material. Base materials made of metal and/or mixtures or composites of the aforementioned materials can also be used for the manufacture of the base material.

In an alternative embodiment of the invention, a provision can be made that the base material has at least two layers of a different material and that the active component is introduced into at least one layer of the base material. In this connection, the term “layer” is to be understood as a layer of the base material, with the active component being introduced into the layer of the base material and/or the layer of the base material being provided with a coating containing the active component. For example, it is possible for the active component to be introduced into an insulating and/or attenuating layer of the base material, preferably into a non-woven fabric or an additional mat, for example a sheep's wool mat. In principle, it is also possible that a layer of the base material consist of the active component as such, with the layer possibly being a woven fabric of protein fibers. The insulating and/or attenuating layer can be provided on the side of the panel or strip facing away from the room. Besides the reduction of the contaminants, the layer also performs other functions, such as acoustic, heat, or sound attenuation, or it contributes to a smoothing-out of the floor or to a regulation of moisture. The active components can also be introduced into substrate materials, e.g. mats or rolls or the like, for placement on the floor. In this manner, the release into the air of pollutants from a contaminated subsurface, for example a contaminated wood floor, can be prevented. In order to do justice to these functions, the layer thickness can be <20 mm, preferably less to or equal than 10 mm. In this way, the layer also differs from the coating also provided on the base material, which is considerably thinner. Moreover, it is of course also possible that the base material have a multilayer construction of layers which are manufactured from the same material.

In order to facilitate a manufacture of the panel or strip according to the invention which is as simple and cost-effective as possible, a provision can be made that the active component is incorporated into the coating or into the layer or into the base material in liquid or powder form. For the sake of simplicity, the active component can be sprinkled or sprayed or rolled into the base material.

Depending on the application, a provision can be made that the coating containing the active component and/or a layer containing the active component is provided on the side of the panel or strip facing the room and/or on the back side. If the front and the back sides are coated or provided with a layer, then a contaminant-reducing effect of the active components occurs both on the front side and on the back side. The front side, for example, absorbs pollutants from the indoor air, whereas the back side absorbs pollutants from the underlying floor, wall or ceiling structures and prevents them from getting into the indoor air. This is especially advantageous in connection with refurbishments, during the use of contaminated chipboards or OSB boards or similarly polluting products. Consequently, it is therefore possible to refurbish existing components and to reduce their emissions.

Catalysts, preferably titanium dioxide, and/or a sorption agent, preferably active coal and/or zeolites and/or silica gel, and/or reactive protein-containing substances, preferably keratin-containing substances and/or animal hair fibers, particularly sheep's wool fibers, can be provided as an active component. The principle of action of the active components can be based on chemical and/or physical sorption and/or a catalytic conversion of the contaminants contained in the indoor air. Depending on the type of bond of the molecules of the contaminants and active components involved, this is physical sorption or chemical sorption, with “sorption” being understood in the context of the invention as a superordinate term for adsorptive and absorptive processes. The active component serves to reduce the concentration of pollutants and odorous materials in the indoor air, with possible pollutants and odorous materials possibly including exhaust gases, cooking vapors, tobacco smoke and substances from sheets of drywall, furniture, paints, lacquers, resins, glues and adhesive agents or the like. The panels or strips according to the invention can be used for refurbishing contaminated rooms or even in connection with the new lining of rooms. Moreover, depending on the selected active component, the active component can also have germ-reducing effects in addition to its indoor air-improving characteristics. Here, it is known, for example, that titanium dioxide can have a germ-killing effect when exposed to UV radiation. Furthermore, it is possible to achieve a combined deposition of pollutants through the use of different active components. For example, it is possible to kill germs contained in the indoor air using TiO₂, whereas the combination of contaminants in the indoor air can be reduced through the use of sheep's wool.

The invention further relates to a care product for surfaces, particularly for the surface treatment of floor, wall or ceiling panels or strips. According to the invention, in order to achieve the object named at the outset, a care product for surfaces is proposed which contains at least one active component with an air pollutant and/or odorous material-reducing effect. The care product according to the invention facilitates the simple and cost-effective, optionally also multilayer coating of a panel or a strip of the afore-described type.

Finally, the invention further relates to a mat, particularly one which can be rolled up, designed for placement onto and/or under the floor, wall or ceiling panels or strips and/or behind furniture, with the mat having at least one active component with an air pollutant- and/or odorous substance-reducing effect. For example, it is possible that the rollable mat be used as a so-called rolled product for placement under floors or behind wall panels or ceiling panels. Instead of using the rolled product, however, it is also possible to use rectangular mat elements. Moreover, it is also possible to place the mat according to the invention behind furniture. What is more, the mat can also consist essentially in its entirety of the active component.

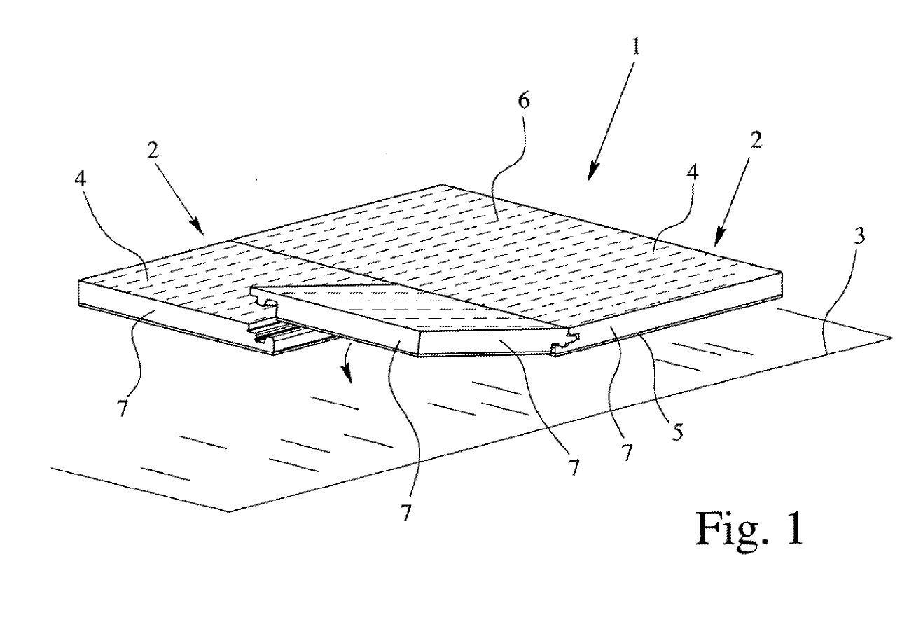

In its details, there are numerous possibilities for designing and modifying the panel according to the invention or the strip according to the invention, for which we refer here to the dependant claims on the one hand and to the following detailed description of a preferred sample embodiment of the invention on the other hand with reference to the drawing. In the drawing, FIG. 1 shows a schematic representation of a floor covering 1 which has a plurality of panels 2 of which only two panels 2 are depicted for the sake of simplicity. The following explanations apply in the same manner to panels which can be used in wall or ceiling coverings and to other plate-like construction materials, even if not discussed in further detail. The individual panels 2 are provided for arrangement or placement on a subsurface 3 of the customer. The present subsurface can be a flooring, drywall or wood floor. Nonetheless, flooring made of other materials, such as ceramic, non-woven fabrics, textiles, soft flooring, or even stone, can be used as a subsurface. Each of the panels 2 has a base material 4 with a floor-side bottom layer 5. A coating 6 is provided on the top side of the base material 4.

In the sample embodiment shown in FIG. 1, a provision is made that both the coating 6 and the bottom layer 5 contain an active component with an air pollutant- and/or odorous substance-reducing effect. In this manner, it is ensured that odorous and harmful substances rising up from the subsurface 3 or emitted by the subsurface 3 as well as the odorous and harmful substances contained in the indoor air above the floor covering 1 are reduced under the sorptive effect and/or catalytic effect of the active component. An active component can be an adsorptive and/or absorptive agent and/or a catalyst. Here, the bottom layer 5 can fulfill other functions; for example, it can be provided as an insulating and/or attenuating material. The coating 6 has a much thinner layer thickness in comparison to the bottom layer 5, although the layer thickness of the coating 6 must be adequate in order to always ensure a sufficient effect of the active components in the event of wear caused by a mechanical load of the floor covering 1. Here, the layer thickness of the coating 6 is determined depending on the use of the panels 2 as a floor, wall or ceiling covering.

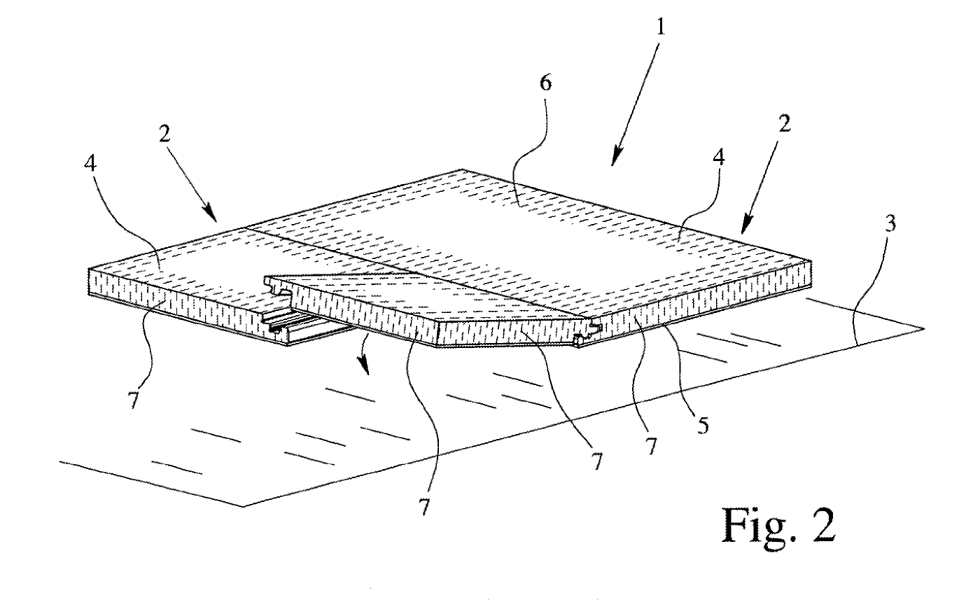

By contrast, in the embodiment depicted in FIG. 2, a partial-surface coating 6 is provided on the top side of the base material 4 in the edge area running around the edges. As will readily be understood, the partial-surface coating 6 is not necessarily limited to the edge area of the base material 4. In principle, the base material 4 can also have a partial-surface coating in other areas of its top side; for example, the top side can be coated in the manner of a pattern. In addition, all four front sides 7 of the panel 2 are coated over their entire surface. However, it is also possible for only one, two or three front sides to be coated. What is more, a provision can be made here that the coating is only provided on part of the surface of the front side(s). In a partial-surface coating, it is possible for only specified areas to be coated, but it is also possible for a coating extending over the entire length of the respective front side to be provided which then, however, does not extend over the entire height of the front side. Preferably, at least the edges of the panels 2 are coated. In the sample embodiment shown in FIG. 2, a further provision is made that all of the coating 6 on the top side and the coated front sides 7 and the bottom layer 5 have an active component with an air pollutant- and/or odorous substance-reducing effect. Preferably, the top side and the front sides 7 are coated with the same active component. By coating the front sides 7, the contaminants rising up particularly in the joint area between the panels 2 and possibly being emitted via the front sides 7 from the inside of the panels 2 are collected.

1. Floor, wall or ceiling panel or strip, designed for placing and/or fastening on a floor, on a wall or on a ceiling of a room, wherein the panel or the strip contains at least one active component with air pollutant- and/or odorous substance-reducing effect, wherein a coated base material is provided and wherein the active component is integrated into the coating (6) of the base material, wherein the coating containing the active component is provided on at least one front side of the panel or the strip.

2. Panel or strip as set forth in claim 1, wherein a catalyst, preferably titanium dioxide, and/or a sorption agent, preferably activated carbon and/or zeolites and/or silica gel, and/or a reactive protein-containing substance, preferably keratin and/or animal hair fibers, particularly sheep's wool fibers, are provided as an active component.

3. Floor, wall or ceiling panel or strip, designed for placing and/or fastening on a floor, on a wall or on a ceiling of a room, wherein the panel or the strip contains at least one active component with air pollutant- and/or odorous substance-reducing effect, wherein a reactive protein-containing substance, preferably keratin, is provided as an active component.

4. Panel or strip as set forth in claim 3, wherein a coated base material is provided, and that the active component is integrated into the coating of the base material.

5. Panel or strip as set forth in claim 3, wherein the coating containing the active component is provided on at least one front side of the panel or the strip.

6. Panel or strip as set forth in claim 1, wherein the top side and/or the bottom side of the base material is coated with the coating containing the active component.

7. Panel or strip as set forth in claim 1, wherein the top side and/or the bottom side are coated only in the outer area near the edge, wherein a strip-like coating is preferably provided which runs along the edges of the panel or the strip.

8. Panel or strip as set forth in claim 1, wherein the front side is coated on a portion of its surface.

9. Panel or strip as set forth in claim 1, wherein the top side and/or the bottom side of the base material is not coated and that, preferably, all front sides are coated.

10. Panel or strip as set forth in claim 1, wherein the coating has a layer thickness of 0.01 mm to 1 mm, preferably of 0.05 mm to 0.5 mm.

11. Panel or strip as set forth in claim 1, wherein the coating contains the active component in a concentration of 1 wt. % to 10 wt. %, preferably of 2 wt. % to 5 wt. %.

12. Panel or strip as set forth in claim 1, wherein the coating contains a carrier substance containing the active component, preferably paint pigments and/or corundum.

13. Panel or strip as set forth in claim 1, wherein the carrier substance is encased with the active component and/or is impregnated with the agent.

14. Panel or strip as set forth in claim 1, wherein a resin coating, particularly a melamine coating, and/or a paint coat and/or a glazing and/or a paper coating and/or foil coating, is provided as a coating.

15. Panel or strip as set forth in claim 1, wherein the coating is sprayed or pressed onto the base material.

16. Panel or strip as set forth in claim 1, wherein the base material contains a layer-forming care product and/or an impregnation and that the active component is introduced into the care product and/or the impregnation.

17. Panel or strip as set forth in claim 1, wherein the active component is introduced into the base material as such.

18. Panel or strip as set forth in claim 1, wherein the base material contains the active component in a concentration of 1 wt. % to 10 wt. %, preferably of 2 wt. % to 5 wt. %.

19. Panel or strip as set forth in claim 1, wherein the base material has at least two layers of a different material and that the active component is introduced into at least one layer of the base material.

20. Panel or strip as set forth in claim 3, wherein the active component is introduced into an insulating and/or attenuating layer of the base material, preferably into a felt mat.

21. Panel or strip as set forth in claim 20, wherein the insulating and/or attenuating layer is provided as a substrate layer on the side of the panel or the strip facing away from the room.

22. Panel or strip as set forth in claim 20, wherein the layer thickness of the layer is 0.5 mm to 5 mm, preferably 1 mm to 2 mm.

23. Panel or strip as set forth in claim 1, wherein the active component is introduced in liquid or in powder form.

24. Panel or strip as set forth in claim 1, wherein the active component is sprinkled or sprayed or rolled into the coating or into the layer or into the base material.

25. Panel or strip as set forth in claim 3, wherein the coating containing the active component and/or a layer containing the active component is provided on the side of the panel or the strip facing the room and/or on its back side.

26. Care product for surfaces, particularly for the surface treatment of floor, wall or ceiling panels or strips, having at least one active component with an air pollutant- and/or odorous substance-reducing effect, wherein the care product can be applied to the panel in a layer-forming manner, with a reactive protein-containing substance, preferably keratin, being provided as an active component.

27. Mat which can be rolled up, designed as a substrate material for placing under or behind floor, wall or ceiling panels or strips and/or behind furniture, wherein the mat contains at least one active component with an air pollutant- and/or odorous substance-reducing effect, wherein a reactive protein-containing substance, preferably keratin, it provided as an active component.
